(19) United States
(12) Patent Application Publication
(10) Pub. No.: US 2012/0064810 A1
(43) Pub. Date: Mar. 15, 2012

(54) DOUBLE-FACED ADHESIVE TAPE AND POLISHING MEMBER

(75) Inventors: Shuuhei YAMAMOTO, Ibaraki-shi (JP); Kazuyuki YAGURA, Ibaraki-shi (JP); Naoyuki NISHIYAMA, Ibaraki-shi (JP); Shouhei WADA, Ibaraki-shi (JP); Hironobu MACHINAGA, Ibaraki-shi (JP)

(73) Assignee: NITTO DENKO CORPORATION, Osaka (JP)

(21) Appl. No.: 13/231,078

(22) Filed: Sep. 13, 2011

(30) Foreign Application Priority Data
Sep. 13, 2010 (JP) 2010-204773

(51) Int. Cl. B24B 41/00; C09J 7/02; B32B 33/00

(52) U.S. Cl. 451/540; 428/41.8; 428/41.3

(57) ABSTRACT

The double-faced adhesive tape has a substrate, an acrylic pressure-sensitive adhesive layer, a rubber pressure-sensitive adhesive layer, and a first release liner that is formed on an external side of the rubber pressure-sensitive adhesive layer, and a second release liner that is formed on an external side of the acrylic pressure-sensitive adhesive layer. The first release liner each has a polymer layer and a paper substrate layer. Further, the second release liner each has a polymer layer and a paper substrate layer. Dynamic friction coefficient on the surface of each polymer layer is less than 1.0, when the coefficient is measured according to JIS K7125.

### BACKGROUND OF THE INVENTION

1. Field of the Invention

The present invention relates to a double-faced adhesive tape for fixing a polishing member, which is used for polishing a material to be polished such as a glass for liquid crystal, on a platen.

2. Description of the Related Art

Conventionally, a polishing apparatus for polishing a surface of a glass for liquid crystal, silicon wafer, and hard disk, etc. has been known. In a polishing apparatus, a double-faced adhesive tape is used for fixing a polishing pad, which supports a material to be polished, on a platen or for fixing a polishing cloth on a platen.

Recently, as the scale of liquid crystal display becomes larger than ever before, the scale of glass for liquid crystal is also increased. A polishing pad or a polishing cloth that is used in a polishing apparatus for polishing a scaled-up member to be polished (Hereinafter, the polishing pad and polishing cloth are together also referred to as a “polishing member”) becomes also lager, and to respond to the need for fixing a large polishing pad or polishing cloth on a platen, a double-faced adhesive tape with wide width is required. For example, as a double-faced adhesive tape with wide width, a double-faced adhesive tape in which a substrate film has width of two meters or more is developed (see Japanese Patent Publication Nos. 2009-262253 and 2010-90359, and International Publication No. 2007/132881).

However, it was found that the handleability of a double-faced adhesive tape for fixing a polishing member such as polishing cloth becomes poor when the tape is prepared to have wide width. More specifically, a polishing member is adhered on one side of an adhesive layer to produce a laminate of a double-faced adhesive tape and a polishing member, which is then prepared as a roll or overlaid with plural sheet-like objects that are cut to have a specific size. In such case, sometimes wrinkles are formed during handling of a laminate. When a polishing member is adhered on a platen while defects such as wrinkles are present on a laminate, the thickness precision required for a polishing member is not obtained, and as a result, a problem may arise in that polishing precision of a member to be polished is affected by it.

### SUMMARY OF THE INVENTION

The invention has been made in view of such a challenge, and the purpose of the invention is to provide a technique for improving handleability of a double-faced adhesive tape for fixing a polishing member on a platen, in particular a double-faced adhesive tape having wide width.

As a result of studies, the inventors of the present invention found that the handleability problem associated with wide width of a double-faced adhesive tape is caused by sliding property of a release liner used for a double-faced adhesive tape. It was also found that, when a dynamic friction coefficient of an exposed surface of a release liner, that is used for a double-faced adhesive tape (i.e. surface of a side that is not in contact with an adhesive layer), is set below a predetermined value, the handleability of a double-faced adhesive tape having wide width can be improved, and therefore the invention was completed.

An embodiment of the present invention is a double-faced adhesive tape. The double-faced adhesive tape is characterized in that it has a substrate, an acrylic pressure-sensitive adhesive layer formed on one surface of the substrate, containing an acrylic polymer as a major component, a rubber pressure-sensitive adhesive layer formed on the other surface of the substrate, containing natural rubber and/or synthetic rubber as a major component, and a release liner laminated on the acrylic pressure-sensitive adhesive layer and/or rubber pressure-sensitive adhesive layer, wherein an exposed surface of the release liner has a dynamic friction coefficient of less than 1.0 when evaluated according to JIS K7125.

According to the double-faced adhesive tape of the aforementioned embodiment, the surface roughness (Ra) of the exposed surface of the release liner may be 0.2 μm or more. The release liner may have, in order from the exposed surface, (A) a polymer layer selected from a group consisting of polyolefins consisting of polyethylene, polypropylene, ethylene-propylene copolymer, and their mixture, and (B) a paper substrate layer selected from a group consisting of glassine paper, craft paper, and high quality paper, wherein the surface of a paper substrate layer on an adhesive layer side may be release-treated. The acrylic polymer may contain the structural unit of (meth)acrylic acid alkyl ester as a major component. The double-faced adhesive tape is suitably used for fixing a polishing member. Further, the double-faced adhesive tape of the aforementioned embodiment may be wound into a roll and the length in a width direction of the roll may be 3,000 mm or less.

Another embodiment of the invention is a polishing member. The polishing member is characterized in that the double-faced adhesive tape according to any one of the aforementioned embodiments is adhered on its surface.

### BRIEF DESCRIPTION OF THE DRAWINGS

FIG. 1 is a schematic sectional view illustrating the configuration of a double-faced adhesive tape according to the embodiment; and

FIG. 2 is a schematic view illustrating the method of measuring dynamic friction coefficient on an exposed surface of a release liner.

### DETAILED DESCRIPTION OF THE INVENTION

The invention will now be described by reference to the preferred embodiments. This does not intend to limit the scope of the invention, but to exemplify the invention.

Hereinafter, the embodiments of the invention will be described in view of the drawings.

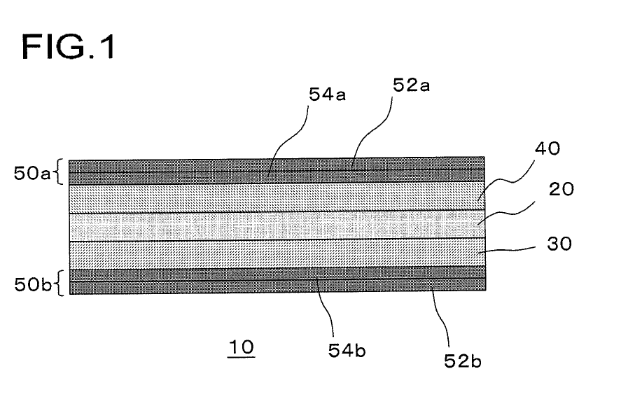

FIG. 1 is a schematic sectional view illustrating the configuration of a double-faced adhesive tape 10 according to the embodiment. The double-faced adhesive tape 10 has a substrate 20, an acrylic pressure-sensitive adhesive layer 30, a rubber pressure-sensitive adhesive layer 40, a release liner 50a, and a release liner 50b. Use of the double-faced adhesive tape 10 according to the embodiment includes fixing of a polishing member such as a polishing cloth and a polishing pad to a platen of a polishing apparatus, that is used for polishing a member to be polished such as glass for liquid crystal.

### (Substrate)

As substrate 20, a plastic film, paper, metal foil, woven cloth, and non-woven cloth may be used. From the viewpoint of strength or thickness precision, a plastic film is preferable, although it is not particularly limited thereto. Examples of the plastic film which can be used include a polyester film such as polyethylene terephthalate and polybutylene terephthalate and a polyolefin film such as polyethylene and polypropylene. Thickness of the substrate can be, for example, 10 μm to 300 μm, and preferably 25 μm to 100 μm, although it is not particularly limited thereto.

### (Acrylic Pressure-Sensitive Adhesive Layer)

The acrylic pressure-sensitive adhesive layer 30 is an adhesive layer which has, as a major component, an acrylic polymer formed on one surface of the substrate 20. Thickness of the acrylic pressure-sensitive adhesive layer 30 is, for example, 20 to 100 μm. The acrylic polymer used for the acrylic pressure-sensitive adhesive layer 30 contains, as a monomer unit, 50% by mass or more of (meth)acrylic acid alkyl ester having C₁₋₂₀ alkyl group. As for the acrylic polymer, the (meth)acrylic acid alkyl ester having C₁₋₂₀ alkyl group may be used alone or in combination of two or more thereof. The acrylic polymer can be obtained by polymerizing (for example, solution polymerization, emulsion polymerization, and UV polymerization) the (meth)acrylic acid alkyl ester along with a polymerization initiator.

The Ratio of the (meth)acrylic acid alkyl ester having C₁₋₂₀ alkyl group is within a range of 50% by mass or more to 99.9% by mass or less based on the total mass of the monomer components for preparing the acrylic polymer, preferably 60% by mass or more, and more preferably 70% by mass or more.

Examples of the (meth)acrylic acid alkyl ester having C₁₋₂₀ alkyl group include, for example, (meth)acrylic acid C₁₋₂₀ alkyl ester such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, (meth)acrylic acid eicosyl, preferably (meth)acrylic acid C₂₋₁₄ alkyl ester, and more preferably (meth)acrylic acid C₂₋₁₀ alkyl ester. Herein, the “The (meth)acrylic acid alkyl ester” means acrylic acid alkyl ester and/or methacrylic acid alkyl ester, and all of the “(meth) . . . ” expressions have the same meaning.

Examples of the (meth)acrylic acid ester other than the (meth)acrylic acid alkyl ester include, for example, (meth)acrylic acid esters having an alicyclic hydrocarbon group, such as cyclopentyl(meth)acrylate, cyclohexyl(meth)acrylate, and isobornyl(meth)acrylate, etc., (meth)acrylic acid esters having an aromatic hydrocarbon group, such as phenyl(meth)acrylate, etc., and (meth)acrylic acid esters obtained from an alcohol derived from a terpene compound, etc.

For the purpose of modifying cohesive force, heat resistance, and cross-linking property, the acrylic polymer may contain, if necessary, another monomer component (copolymerizable monomer) that is copolymerizable with the (meth)acrylic acid alkyl ester. Accordingly, the acrylic polymer may contain a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as acrylic acid, methacrylic acid, carboxy ethyl acrylate, carboxy pentylacrylate, itaconic acid, maleic acid, fumaric acid, crotonic acid, and isocrotonic acid, etc.; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate, etc.; acid anhydride group-containing monomers, such as maleic acid anhydride, and itaconic acid anhydride, etc.; sulfonic acid group-containing monomers, such as styrene sulfonic acid, allyl sulfonic acid, 2-(meth)acrylamide-2-methylpropanesulfonic acid, (meth)acrylamide propane sulfonic acid, sulfopropyl(meth)acrylate, and (meth)acryloyloxy naphthalene sulfonic acid, etc.; phosphate group-containing monomers, such as 2-hydroxyethyl acryloyl phosphate, etc.; (N-substituted) amide monomers, such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylol propane(meth)acrylamide, N-methoxymethyl(meth)acrylamide, and N-butoxymethyl(meth)acrylamide, etc.; succinimide monomers, such as N-(meth)acryloyloxy methylene succinimide, N-(meth)acryloyl-6-oxy hexamethylene succinimide, and N-(meth)acryloyl-8-oxy hexamethylene succinimide, etc.; maleimide monomers, such as N-cyclohexyl maleimide, N-isopropylmaleimide, N-lauryl maleimide, and N-phenyl maleimide, etc.; itaconimide monomers, such as N-methyl itaconimide, N-ethyl itaconimide, N-butyl itaconimide, N-octyl itaconimide, N-2-ethylhexyl itaconimide, N-cyclohexyl itaconimide, and N-lauryl itaconimide, etc.; vinyl esters, such as vinyl acetate and vinyl propionate, etc.; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, and N-vinyl morpholine, etc.; N-vinyl carboxylic acid amides; lactam monomers, such as N-vinyl caprolactam, etc.; cyanoacrylate monomers, such as acrylonitrile and methacrylonitrile, etc.; (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl, etc.; (meth)acrylic acid alkoxy alkyl monomers, such as (meth)acrylic acid methoxyethyl, and (meth)acrylic acid ethoxyethyl, etc.; styrene monomers, such as styrene and a-methylstyrene, etc.; epoxy group-containing acrylic monomers, such as (meth)acrylic acid glycidyl, etc.; glycol acrylic ester monomers, such as (meth)acrylic acid polyethylene glycol, (meth)acrylic acid polypropylene glycol, (meth)acrylic acid methoxy ethylene glycol, and (meth)acrylic acid methoxy polypropylene glycol, etc.; acrylic acid ester monomers having a heterocycle, halogen atom, silicon atom, or the like, such as (meth)acrylic acid tetrahydrofurfuryl, fluoro(meth)acrylate, and silicone(meth)acrylate, etc.; olefin monomers, such as isoprene, butadiene, and isobutylene, etc.; vinyl ether monomers, such as methyl vinyl ether, and ethyl vinyl ether, etc.; thioglycolic acid; vinyl esters, such as vinyl acetate, and vinyl propionate, etc.; aromatic vinyl compounds such as styrene, and vinyl toluene, etc.; olefins or dienes, such as ethylene, butadiene, isoprene, and isobutylene, etc.; vinyl ethers, such as vinyl alkyl ether, etc.; vinyl chloride; (meth)acrylic acid alkoxy alkyl monomers, such as (meth)acrylic acid methoxyethyl and (meth)acrylic acid ethoxyethyl, etc.; sulfonic acid group-containing monomers such as vinyl sulfonate sodium, etc.; imide group-containing monomers, such as cyclohexyl maleimide and isopropyl maleimide, etc.; isocyanate group-containing monomers, such as 2-isocyanate ethyl(meth)acrylate, etc.; fluorine atom-containing (meth)acrylates; and silicon atom-containing (meth)acrylates, etc. These copolymerizable monomers can be used alone or in combination of two or more thereof.

When the acrylic polymer contains a copolymerizable monomer along with the (meth)acrylic acid alkyl ester as a major component, carboxyl group-containing monomers can be preferably used. Among them, an acrylic acid can be preferably used. The use amount of the copolymerizable monomer is not particularly limited, but the copolymerizable monomer can be usually contained in an amount within a range of 0.1% to 30% by mass based on the total mass of the monomer components for preparing the acrylic polymer, preferably in an amount within a range of 0.5% to 20% by mass, and more preferably in an amount within a range of 1% to 15% by mass.

By containing the copolymerizable monomer in an amount of 0.1% by mass or more, a decrease in the cohesive force of the acrylic adhesive tape or sheet that is produced by including an acrylic adhesive can be prevented and high shear force can be obtained. Further, by making the content of the copolymerizable monomer to be 30% by mass or less, it can be prevented that the cohesive force may become too high and the tackiness at normal temperature (25° C.) can be improved.

A polyfunctional monomer may be contained, if necessary, in the acrylic polymer in order to adjust the cohesive force of the acrylic adhesive to be formed.

Examples of the polyfunctional polymer include, for example, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecane diol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butyl di(meth)acrylate, and hexyl di(meth)acrylate, etc. Among them, trimethylolpropane tri(meth)acrylate, hexanediol di(meth)acrylate, and dipentaerythritol hexa(meth)acrylate can be preferably used. The polyfunctional (meth)acrylates can be used alone or in combination of two or more thereof.

The use amount of the polyfunctional monomer is changed depending on the molecular weight or the number of functional groups thereof, but the polyfunctional monomer is added in an amount within a range of 0.01% to 3.0% by mass based on the total mass of the monomer components for preparing the acrylic polymer, preferably in an amount within a range of 0.02% to 2.0% by mass, and more preferably in an amount within a range of 0.03% to 1.0% by mass.

If the use amount of the polyfunctional monomer exceeds 3.0% by mass based on the total mass of the monomer components for preparing the acrylic polymer, for example, the cohesive force of the acrylic adhesive may become too high and accordingly there are sometimes the cases where the adhesive force maybe decreased. On the other hand, when the use amount thereof is below 0.01% by mass, for example, there are sometimes the cases where the cohesive force of the acrylic adhesive maybe decreased.

### <Polymerization Initiator>

In preparing the acrylic polymer, the acrylic polymer can be easily formed by a curing reaction using heat or ultraviolet rays with the use of a polymerization initiator, such as thermal polymerization initiator, photo-polymerization initiator (photo-initiator), or the like. In particular, a photo-polymerization initiator can be preferably used in terms of the advantage that a polymerization time can be shortened. The polymerization initiators can be used alone or in combination of two or more thereof.

Examples of the thermal polymerization initiator include, for example: azo polymerization initiators [for example, 2,2′-azobis isobutyronitrile, 2,2′-azobis-2-methylbutyronitrile, 2,2′-azobis(2-methylpropionic acid)dimethyl, 4,4′-azobis-4-cyanovaleric acid, azobis isovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine)dihydrochloride, etc.]; peroxide polymerization initiators (for example, dibenzoyl peroxide, t-butyl permaleate, and lauroyl peroxide, etc.); and redox polymerization initiator, etc.

The use amount of the thermal polymerization initiator is not particularly limited, and only has to be within a conventional range in which it can be used as a thermal polymerization initiator.

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethan-1-one [made by BASF, product name: IRGACURE 651], and anisole methyl ether, etc. Specific examples of the acetophenone photo-polymerization initiator include, for example: 1-hydroxycyclohexyl phenyl ketone [made by BASF, product name: IRGACURE 184], 4-phenoxy dichloro acetophenone, 4-t-butyl-dichloroacetophenone, 1-[4-(2-hydroxyethoxy)-phenyl]-2-hydroxy-2-methyl-1-propan-1-one [made by BASF, product name: IRGACURE 2959], 2-hydroxy-2-methyl-1-phenyl-propan-1-one [made by BASF, product name: DAROCUR 1173], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropan-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,1-propanedione-2-(o-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Specific examples of the thioxanthone photo-polymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine photo-polymerization initiator include, for example: bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methypropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

Among them, bis(2,4,6-trimethylbenzoyl)phenylphosphine oxide [made by BASF, product name: IRGACURE 819], bis(2,4,6-trimethylbenzoyl)-2,4-di-n-butoxyphenylphosphine oxide, 2,4,6-trimethylbenzoyl diphenylphosphine oxide [made by BASF, product name: Lucirin TPO], and bis(2,6-dimethoxybenzoyl)-2,4,4-trimethylpentylphosphine oxide, are particularly preferred.

The use amount of the photo-polymerization initiator is not particularly limited, but the photo-polymerization initiator is combined in an amount within a range of, for example, 0.01 to 5 parts by mass based on 100 parts by mass of the monomer components for preparing the acrylic polymer, preferably in an amount within a range of 0.05 to 3 parts by mass, and more preferably in an amount within a range of 0.08 to 2 parts by mass.

If the use amount of the photo-polymerization initiator is less than 0.01 parts by mass, there are sometimes the cases where a polymerization reaction is insufficient. If the use amount thereof exceeds 5 parts by mass, there is the fear that, because the photo-polymerization initiator absorbs an ultraviolet ray, an ultraviolet ray may not reach the inside of the adhesive layer, thereby causing a decrease in the polymerization ratio, or the molecular weight of the polymer to be generated becomes small, and therefore there is a fear that the cohesive force of the adhesive layer to be formed may become low and part of the adhesive layer remains on the film when the adhesive layer is peeled from the film, and as a result, the film may not be recycled. The photo-polymerization initiators maybe used alone or in combination of two or more thereof.

Besides the aforementioned polyfunctional monomers, a cross-linking agent can also be used for adjusting the cohesive force. Commonly-used cross-linking agents can be used as the cross-linking agent. Examples of the cross-linking agents include epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. Among them, in particular, the isocyanate cross-linking agent and epoxy cross-linking agent can be preferably used.

Specific examples of the isocyanate cross-linking agent include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isocyanate, and these adducts with polyols, such as trimethylolpropane, etc.

Examples of the epoxy cross-linking agent include bisphenol A, epichlorohydrin type epoxy resin, ethylene glycidyl ether, polyethylene glycol diglycidyl ether, glycerin diglycidyl ether, glycerin triglycidyl ether, 1, 6-hexanediol glycidyl ether, trimethylolpropane triglycidyl ether, diglycidyl aniline, diamine glycidyl amine, N,N,N′,N′-tetraglycidyl-m-xylylenediamine, and 1,3-bis(N,N′-diamine glycidyl aminomethyl)cyclohexane, etc. The addition amount of the cross-linking agent is, compared to 100 parts by mass of the acrylic polymer, 0.001 to 10 parts by mass, for example, although it is not particularly limited thereto.

### <Other Components>

Besides the aforementioned components, an appropriate additive such as a tackifier, a softening agent, a plasticizer, a filler, an anti-aging agent, and a colorant, may be added in the acrylic pressure-sensitive adhesive layer 30, if necessary.

Examples of the tackifier which can be used include a rosin-based tackifier, a terpene-based tackifier, a phenol-based tackifier, and a petroleum-based tackifier.

### (Rubber Pressure-Sensitive Adhesive Layer)

The rubber pressure-sensitive adhesive layer 40 is an adhesive layer formed on the other surface of the substrate 20, containing natural rubber and/or synthetic rubber as a major component. Thickness of the rubber pressure-sensitive adhesive layer 40 is, for example, from 20 μm to 100 μm. The synthetic rubber used for the rubber pressure-sensitive adhesive layer 40 is not particularly limited, and examples thereof include a styrene-isoprene-styrene block copolymer, a styrene-butadiene-styrene block copolymer, a hydrogenated product of the styrenic block copolymer, styrene-butadiene rubber (SBR), polyisoprene rubber (IR), polyisobutylene (PIB), and butylated rubber (IIR).

The natural rubber is not particularly limited, and it is used after mixing with a mixing roll and controlling the Mooney viscosity from 10 to 100 or so, for example.

In addition to the natural rubber and/or synthetic rubber, a tackifier may be further included. Examples of the tackifier include a terpene phenol resin, a rosin-based resin, and a petroleum-based resin. The addition amount of the tackifying resin can be selected within the range that the tackifying effect is not impaired, and it is, for example, 20 to 150 parts by mass compared to 100 parts by mass of the natural rubber and/or synthetic rubber.

In the rubber pressure-sensitive adhesive layer, if necessary, an appropriate additive such as a softening agent, a plasticizer, a filler, an anti-aging agent, and a colorant, may be included in addition to the aforementioned components.

### (Release Liner)

The release liner 50a is laminated on an adhesive surface of the rubber pressure-sensitive adhesive layer 40 on its side opposite to the substrate 20. The release liner 50a has, from the exposed surface, (A) polymer layer 52a and (B) paper substrate layer 54a in order.

(A) Polymer layer 52a is selected from a group consisting of polyolefin consisting of polyethylene, polypropylene, ethylene-propylene copolymer, or a mixture thereof . Thickness of the polymer layer 52a is, for example, from 10 μm to 300 μm.

(B) Paper substrate layer 54a is selected from a group consisting of glassine paper, craft paper, and high quality paper.

Thickness of the paper substrate layer 54a is, for example, from 50 μm to 200 μm. Surface of the paper substrate layer 54a on the rubber pressure-sensitive adhesive layer 40 side is preferably release-treated with a releasing agent such as silicon-based releasing agent.

The release liner 50b is laminated on an adhesive surface of the acrylic pressure-sensitive adhesive layer 30 on its side opposite to the substrate 20. The release liner 50b has, from the exposed surface, (C) polymer layer 52b and (D) paper substrate layer 54b in order. (C) Polymer layer 52b and (D) paper substrate layer 54b each correspond to (A) polymer layer 52a and (B) paper substrate layer 54a of the release liner 50a, respectively, and therefore no further explanations are given. Hereinafter, both the release liner 50a and the release liner 50b are sometimes referred to as a release liner 50.

According to this embodiment, the dynamic friction coefficient on the exposed surface of the release liner 50 (50a, 50b) (i.e. surface of the side that is not contact with an adhesive layer) is less than 1.0, and preferably between 0.1 and 0.85, wherein the dynamic friction coefficient is measured according to JIS K7125. Method of measuring a dynamic friction coefficient is described below. In the invention, to have the dynamic friction coefficient of the release liner within the specific range above, surface roughness (Ra) of the exposed surface of the release liner 50 is 0.2 μm or more, preferably between 0.4 μm and 3.0 μm. Further, in this embodiment, the surface roughness (Ra) of the exposed surface of the release liner 50 is measured by using a surface roughness tester. Further, the surface roughness (Ra) of the exposed surface of the release liner 50 may be controlled by quality or roughness of a paper substrate, quality choice or thickness of a polymer layer, or surface treatment of a polymer layer surface (e.g., roughening treatment such as mattifying treatment, semi-mattifying treatment, and embossing treatment).

The double-faced adhesive tape 10 of this embodiment can have further improved handleability when it is prepared to have wide width. Specifically, the width of the double-faced adhesive tape is preferably between 1,300 mm and 3,000 mm, more preferably between 1,500 mm and 2,800 mm, and still more preferably between 2,100 mm and 2,500 mm.

For the double-faced adhesive tape 10 of this embodiment, it is preferable that a substrate or a release liner having wide width (preferably between 2,100 mm and 3,000 mm, and more preferably 2,500 mm and 3,000 mm) is prepared and an adhesive composition is coated by using an apparatus for coating an adhesive composition, that has a wide width corresponding to the width of the substrate or release liner. As for the wide-width apparatus for coating an adhesive composition, it is preferable to carryout coating by using a coating apparatus having roll width of between 2,100 mm and 3,000 mm such as a Gravure coater, a fountain die coater, a lip coater, and a comma coater. By coating in bulk an adhesive layer with wide width by using the wide-width apparatus for coating an adhesive composition, a risk of having an appearance defect can be further reduced.

According to the double-faced adhesive tape 10 of this embodiment, surface of the release liner has an improved sliding property. As a result, when a polishing member is adhered on one side of an adhesive layer to produce a laminate of a double-faced adhesive tape and a polishing member, which is then prepared as a roll or overlaid with plural sheet-like objects that are cut to have a pre-determined size, no wrinkles are formed on the laminate. As a result, the double-faced adhesive tape 10 can be evenly adhered over the entire surface of a polishing member, fixing of a polishing member to a platen can be further strengthened, and as having little difference in height (i.e. uneven thickness), polishing process can be achieved with high precision.

Further, although the release liner 50 is formed on both side of the acrylic adhesive layer 30 and the rubber pressure-sensitive adhesive layer 40 in the double-faced adhesive tape 10 of this embodiment, the release liner 50 may be formed on any one side of the acrylic adhesive layer 30 and the rubber pressure-sensitive adhesive layer 40.

The double-faced adhesive tape 10 of this embodiment is suitably used for fixing a polishing member. In such case, it is preferable that the acrylic pressure-sensitive adhesive layer is used for fixing a polishing pad or a polishing cloth and the rubber pressure-sensitive adhesive layer is used for fixing a platen, even though it is not particularly limited thereto.

### EXAMPLES

Hereinafter, the invention will be described in detail based on Examples, but the invention should not be limited at all by these Examples.

In Table 1, components and layer thickness of a double-faced adhesive tape of the Example 1, Comparative Example 1, and Comparative Example 2 are shown.

TABLE 1

| | | | | Comparative | Comparative |
|---|---|---|---|---|---|
| | | | Example 1 | Example 1 | Example 2 |
| Release liner A (on | Polymer | Material | Polyethylene | Polyethylene | Polyethylene |
| acrylic | layer | Layer thickness (mm) | 19 | 20 | 20 |
| pressure-sensitive | Paper | Material | Glassine paper | Craft paper | Craft paper |
| adhesive layer) | substrate | Basis weight (g/m²) | 55 | 70 | 70 |
| | layer | | | | |
| Rubber | Material | | Natural rubber | Natural rubber | Natural rubber |
| pressure-sensitive | | | synthetic rubber | synthetic rubber | synthetic rubber |
| adhesive layer | Layer thickness (mm) | | 40 | 40 | 40 |
| Substrate | Material | | PET | PET | PET |
| | Layer thickness (mm) | | 75 | 75 | 75 |
| Acrylic | Material | | Acrylic polymer | Acrylic polymer | Acrylic polymer |
| pressure-sensitive | Layer thickness (mm) | | 60 | 60 | 60 |
| adhesive layer | | | | | |
| Release liner B | Paper | Material | Glassine paper | Craft paper | Craft paper |
| (on rubber | substrate | Basis weight (g/m²) | 55 | 70 | 70 |
| pressure-sensitive | layer | | | | |
| adhesive layer) | Polymer | Material | Polyethylene | Polyethylene | Polyethylene |
| | layer | Layer thickness (mm) | 19 | 20 | 20 |

| | | | |
|---|---|---|---|
| Release treatment of each release liner on paper substrate side | Silicone | Silicone | Silicone |
| | releasing agent | releasing agent | releasing agent |

### Example 1

The double-faced adhesive tape 10 of the Example 1 was produced according to the following process.

### <Production of Acrylic Adhesive Composition>

Butyl acrylate (70 parts by mass), 2-ethylhexyl acrylate (30 parts by mass), acrylic acid (3 parts by mass), 4-hydroxybutyl acrylate (0.05 parts by mass), andAIBN (azobis isobutyronitrile, 0.08 parts by mass) as a polymerization initiator were added to a mixture solvent having 151 parts by mass of toluene. After that, the solution polymerization was carried out for 6 hours at 60° C. to obtain a polymer solution for acrylic adhesives (viscosity: 28 Pa·s, solid component: 40% by mass). The acrylate polymer in the acrylic adhesive polymer solution has weight average molecular weight of 440,000. To 100 parts by mass of the resulting polymer solution for acrylic adhesives, 30 parts by mass of rosin pentaerythritol ester (made by Arakawa Chemical Industries, Ltd., product name: PENCEL D125) was added and 2 parts by mass of isocyanate (made by Nippon Polyurethane Industry Co., Ltd., product name: CORONATE L) was also added as a cross-linking agent to give an acrylic adhesive composition.

### <Production of Rubber-Based Adhesive Composition>

Natural rubber (100 parts by mass), SIS (30 parts by mass, trade name: QUINTAC 3460C, manufactured by Zeon Corporation, a radiate configuration SIS, styrene content of 25% by mass), modified maleic anhydride C5, C9 resin (40 parts by mass, trade name: QUINTONE D-200, manufactured by Zeon Corporation), phenol modified resin (40 parts by mass, trade name: SUMILITE PR12603N, manufactured by Sumitomo Bakelite Co., Ltd.), and a phenol-based anti-aging agent (1 part by weight, trade name: NOCRAC NS-6, manufactured by Ouchi Shinko Chemical Industrial Co., Ltd.) were dissolved in toluene. After that, 3 parts by mass of isocyanate (made by Nippon Polyurethane Industry Co., Ltd., product name: CORONATE L) was also added as a cross-linking agent to give a rubber-based adhesive composition.

### <Production of Adhesive Layer>

A paper substrate layer made of glassine paper (55 g/m²) wherein a polymer layer (thickness of 19 μm) consisting of polyethylene is laminated on one side of the paper was prepared. Surface of the polymer layer consisting of polyethylene (i.e. exposed surface) was brought into contact with a cooling roll processed with a semi-mattifying treatment. On the surface side of the paper substrate layer that is opposite to the side laminated with the polymer layer, release treatment was carried out by using a silicone releasing agent to prepare the release liner A. With the same process as the release liner A, the release liner B was prepared. Meanwhile, the surface roughness Ra of the exposed surface of the release liner A and release liner B was 0.48 μm. Width of the release liner A and release liner B was 2,500 mm.

As a substrate, a polyethylene terephthalate (PET) film having thickness of 75 μm and width of 2,500 mm was prepared.

On one side of the substrate, the acrylic adhesive composition was coated by using an adhesive coater (comma coater) with coating width of 2,500 mm. The solvent was removed by heating for 3 min in an oven at 100° C., and as a result, a laminate A having an acrylic pressure-sensitive adhesive layer with width of 2,500 mm and thickness of 60 μm after drying was produced.

Next, by directing the paper substrate layer side of the release liner A (i.e. surface subjected to release treatment with a silicone releasing agent) toward the surface of an acrylic pressure-sensitive adhesive layer, the release liner A was laminated on the acrylic pressure-sensitive adhesive layer.

On the paper substrate layer side of the release liner B (i.e. surface subjected to release treatment with a silicone releasing agent), a rubber-based adhesive composition was coated by using an adhesive coater (comma coater) with coating width of 2,500 mm. The solvent was removed by heating for 3 min in an oven at 100° C., and as a result a laminate B having a rubber pressure-sensitive adhesive layer with width of 2,500 mm and thickness of 40 μm after drying was produced.

Next, by directing the substrate side of the laminate A toward the rubber pressure-sensitive adhesive layer of the laminate B, the laminate A was laminated on the laminate B to obtain the double-faced adhesive tape of the Example 1 (release liner A/acrylic pressure-sensitive adhesive layer/PET film/rubber pressure-sensitive adhesive layer/release liner B). Further, the length in a width direction of the double-faced adhesive tape of the Example 1 was 2,500 mm.

### Comparative Examples 1 and 2

The double-faced adhesive tape of the Comparative Example 1 and Comparative Example 2 was produced in the same process as the Example 1 except that craft paper on a paper substrate layer is used as a release liner, thickness of a polymer layer and no contact is made with a cooling roll processed with semi-mattifying treatment, and basis weight of the paper substrate layer is changed.

### (Evaluation of Surface Roughness)

Surface roughness (Ra) of the exposed surface of the release liner in the Example 1, Comparative Example 1, and Comparative Example 2 was measured with contact type surface roughness tester (made by Mitutoyo Corporation, product name: SJ-400) with measurement length of 4 mm, measurement speed of 0.5 mm/min, and cut off value of 0.8 mm. Results of evaluating surface roughness are shown in Table 2. The surface roughness of the release liner of the Example 1 is larger than that of the Comparative Examples 1 and 2. Such result is believed due to the fact that surface roughness of a polymer layer is increased by roughness of a paper substrate layer as a base for the polymer layer, and a semi-mattified surface of a cooling roll, that is used for lamination of a polymer layer consisting of polyethylene on the paper substrate layer of release liner, is transferred thereto. Further, the difference in surface roughness between the Comparative Example 1 and Comparative Example 2 is believed due to the fact that roughness of the paper substrate layer is different and a cooling roll not processed with a semi-mattifying treatment is used as a cooling roll for laminating a polymer layer consisting of polyethylene on a paper substrate layer of release liner.

### (Measurement of Dynamic Friction Coefficient on Exposed Surface of Release Liner)

Dynamic friction coefficient (sliding property) on an exposed surface of each release liner, that is used for a double-faced adhesive tape of the Example 1, Comparative Example 1, and Comparative Example 2, was evaluated according to the following method.

To a test specimen having total weight of 200 g (load of 1.96 N) applied with a rubber plate (an elastic material to obtain even pressure contribution, length 63 mm×width 63 mm: area of 40 cm²) for attaching a sample, a paper substrate layer side (i.e. a surface subjected to release treatment with a silicone-based releasing agent) of a release liner (length 63 mm×width 63 mm: area of 40 cm²) was applied by using a double-faced tape to produce a sliding piece (area of 40 cm²).

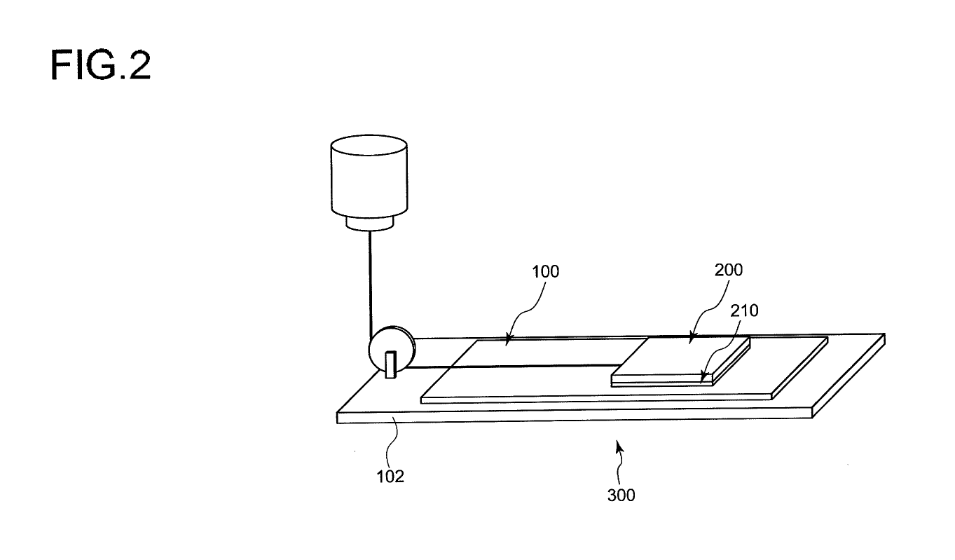

As shown in FIG. 2, a chloroprene rubber plate 100(made by IRUMAGAWA RUBBER CO., LTD., product name: NEO-200 <3.0 mm product, length 300 mm×width 200 mm) was placed on a testing board 102, and the sliding piece 200 was loaded on the surface of one end of the chloroprene rubber plate 100 so that a release liner 210 is in contact with the chloroprene rubber plate 100.

By using a tensile tester 300, dynamic friction force is measured when the sliding piece is pulled in horizontal direction with a rate of 100 mm/min. With the dynamic friction force measured, the friction coefficient is calculated according to the following equation.

Dynamic friction coefficient=Dynamic friction force [N]/Mass of sliding piece [1.96 N]

The dynamic friction coefficient obtained is described in Table 2.

TABLE 2

| | | Comparative | Comparative |
|---|---|---|---|
| | Example 1 | Example 1 | Example 2 |
| Surface roughness (μm) | 0.48 | 0.1 | 0.16 |
| Dynamic friction | 0.83 | 1.5 | 1 |
| coefficient (—) | | | |
| Presence or absence of | ∘ | x | x |
| wrinkles caused by winding | | | |
| when prepared in barrel form | | | |

Considering the evaluation results of surface roughness and sliding property described in Table 2, it is believed that contact area between the release liner and the rubber plate is decreased as the surface roughness of the release liner increases, and as a result, sliding property of the release liner is improved.

### (Evaluation of Wrinkles Caused by Winding)

The double-faced adhesive tape of the Example 1, Comparative Example 1, and Comparative Example 2, which has been cut to have a width of 2,500 mm and a length of 1,000 mm, was rolled into barrel form, and then the presence or absence of wrinkles caused by winding was determined. The evaluation results of wrinkles caused by winding are given in Table 2. With the double-faced adhesive tape of the Example 1, no wrinkles caused by winding were observed. On the contrary, with the double-faced adhesive tape of the Comparative Example 1 and Comparative Example 2, wrinkles caused by winding were observed. This is believed due to the fact that, as the sliding property of the release liner for the double-faced adhesive tape of the Example 1 is improved, the contact region at the time of winding the double-faced adhesive tape into barrel form is moderately slipped so that the occurrence of wrinkles caused by winding is inhibited.

The aforementioned embodiments are summarized as follows.
(Item 1) A double-faced adhesive tape, having

a substrate,

an acrylic pressure-sensitive adhesive layer formed on one surface of the substrate, containing an acrylic polymer as a major component,

a rubber pressure-sensitive adhesive layer formed on the other surface of the substrate, containing natural rubber and/or synthetic rubber as a major component, and

a release liner laminated on the acrylic pressure-sensitive adhesive layer and/or rubber pressure-sensitive adhesive layer,

wherein an exposed surface of the release liner has a dynamic friction coefficient of less than 1.0 as evaluated according to JIS K7125.
(Item 2) The double-faced adhesive tape described in above Item 1, wherein surface roughness (Ra) of the exposed surface of the release liner is 0.2 μm or more.
(Item 3) The double-faced adhesive tape described in above Item 1 or 2, wherein the release liner has, in order from the exposed surface,

(A) a polymer layer selected from a group consisting of polyolefins consisting of polyethylene, polypropylene, ethylene-propylene copolymer, and their mixture, and

(B) a paper substrate layer selected from a group consisting of glassine paper, craft paper, and high quality paper,

wherein the surface of the paper substrate layer on the adhesive layer side is release-treated.
(Item 4) The double-faced adhesive tape described in any one of above Items 1 to 3, wherein the acrylic polymer contains the structural unit of (meth)acrylic acid alkyl ester as a major component.
(Item 5) The double-faced adhesive tape described in any one of above Items 1 to 4, wherein it is used for fixing a polishing member.
(Item 6) The double-faced adhesive tape described in any one of above Items 1 to 5, wherein it is wound into a roll and the length in a width direction of the roll is 3,000 mm or less.
(Item 7) A polishing member, wherein the double-faced adhesive tape described in any one of above Items 1 to 6 is adhered on its surface.

What is claimed is:

1. A double-faced adhesive tape, comprising:
a substrate;
an acrylic pressure-sensitive adhesive layer formed on one surface of the substrate, containing an acrylic polymer as a major component;
a rubber pressure-sensitive adhesive layer formed on the other surface of the substrate, containing natural rubber and/or synthetic rubber as a major component; and
a release liner laminated on the acrylic pressure-sensitive adhesive layer and/or rubber pressure-sensitive adhesive layer,
wherein
an exposed surface of the release liner has a dynamic friction coefficient of less than 1.0 as evaluated according to JIS K7125.

2. The double-faced adhesive tape according to claim 1, wherein
surface roughness (Ra) of the exposed surface of the release liner is 0.2 μm or more.

3. The double-faced adhesive tape according to claim 1, wherein
the release liner comprises, in order from the exposed surface:
(A) a polymer layer selected from a group consisting of polyolefins consisting of polyethylene, polypropylene, ethylene-propylene copolymer, and their mixture; and
(B) a paper substrate layer selected from a group consisting of glassine paper, craft paper, and high quality paper,
wherein the surface of the paper substrate layer on the adhesive layer side is release-treated.

4. The double-faced adhesive tape according to claim 1, wherein
the acrylic polymer comprises the structural unit of (meth)acrylic acid alkyl ester as a major component.

5. The double-faced adhesive tape according to claim 1, wherein
the double-faced adhesive tape is used for fixing a polishing member.

6. The double-faced adhesive tape according to claim 1, wherein
the double-faced adhesive tape is wound into a roll and the length in a width direction of the roll is 3,000 mm or less.

7. A polishing member, wherein
the double-faced adhesive tape described in claim 1 is adhered on its surface.

8. The double-faced adhesive tape according to claim 2, wherein
the release liner comprises, in order from the exposed surface:
(A) a polymer layer selected from a group consisting of polyolefins consisting of polyethylene, polypropylene, ethylene-propylene copolymer, and their mixture; and
(B) a paper substrate layer selected from a group consisting of glassine paper, craft paper, and high quality paper,
wherein the surface of the paper substrate layer on the adhesive layer side is release-treated.

9. The double-faced adhesive tape according to claim 2, wherein
the acrylic polymer contains the structural unit of (meth)acrylic acid alkyl ester as a major component.

10. The double-faced adhesive tape according to claim 3, wherein
the acrylic polymer contains the structural unit of (meth)acrylic acid alkyl ester as a major component.

11. The double-faced adhesive tape according to claim 8, wherein
the acrylic polymer contains the structural unit of (meth)acrylic acid alkyl ester as a major component.

12. The double-faced adhesive tape according to claim 2, wherein
the double-faced adhesive tape is used for fixing a polishing member.

13. The double-faced adhesive tape according to claim 3, wherein
the double-faced adhesive tape is used for fixing a polishing member.

14. The double-faced adhesive tape according to claim 4, wherein
the double-faced adhesive tape is used for fixing a polishing member.

15. The double-faced adhesive tape according to claim 8, wherein
the double-faced adhesive tape is used for fixing a polishing member.

16. The double-faced adhesive tape according to claim 9, wherein
the double-faced adhesive tape is used for fixing a polishing member.

17. The double-faced adhesive tape according to claim 10, wherein
the double-faced adhesive tape is used for fixing a polishing member.

18. The double-faced adhesive tape according to claim 11, wherein
the double-faced adhesive tape is used for fixing a polishing member.

19. The double-faced adhesive tape according to claim 2, wherein
the double-faced adhesive tape is wound into a roll and the length in a width direction of the roll is 3,000 mm or less.

20. The double-faced adhesive tape according to claim 3, wherein
the double-faced adhesive tape is wound into a roll and the length in a width direction of the roll is 3,000 mm or less.
